(19) United States
(12) Patent Application Publication
(10) Pub. No.: US 2013/0020192 A1
(43) Pub. Date: Jan. 24, 2013

(54) Wind Turbine Fuel Generation System

(71) Applicant: Larry Carpenter, Jupiter, FL (US)

(72) Inventor: Larry Carpenter, Jupiter, FL (US)

(21) Appl. No.: 13/184,768

(22) Filed: Jul. 18, 2011

(51) Int. Cl. C25B 15/02; C25B 9/00; H02P 9/04

(52) U.S. Cl. 204/228.3; 290/44; 204/242

(57) ABSTRACT

A wind turbine for use in the generation of electricity employs a generator which enables the efficient production of DC electrical power through the use of a low and variable speed and variable torque design. This design eliminates the cost and complexity of variable pitch turbine blades and/or mechanical gear boxes. The design includes a large diameter axial flux generator which utilizes either permanent magnets or current induced field coils. The design preferably employs an equal number of armature coils and field coils or permanent magnets in the case of single phase operation or 1⅓ field coils or permanent magnets for every armature coil for three phase operation. The three phase operation can also be accomplished by using three separate rotor disks on the generator with appropriate indexing of the rotor disk and armature coils.

### FIELD OF THE INVENTION

The invention relates to a wind turbine for efficient production of DC power through the use of a low and variable speed torque design; and in particular to a wind turbine without variable pitch blades and/or mechanical gear boxes.

### BACKGROUND OF THE INVENTION

The world has been relying on fossil fuels to meet its energy needs. As the world needs grow, the supply of fossil fuels has been increased to meet these needs. However, this has led to a depletion of the supply of fossil fuels. In addition, use of these fossil fuels has led to an increase in air pollution and related health risks. Thus, there is a growing need for non-polluting renewable energy sources. One of these renewable resources is wind energy.

Wind energy was first utilized by the Greeks in the first century A.D. to perform very simple tasks. It has since been utilized in Europe via windmills to perform simple mechanical tasks such as corn milling, land drainage, saw milling, etc. These windmills required that tasks to be performed be located proximate to the windmills since there was no reliable manner in which to transmit the wind energy to other locations. The invention of the electric motor and electric generator has enabled energy to be transmitted to various locations separate and distinct from the source of the energy. Water energy was first converted to electrical energy by the use of falling water passing through hydroelectric turbine generators. This is still in use today in the form of hydroelectric turbine generators located in dams.

Wind energy conversion to electrical energy is rapidly expanding. There are wind farms at various locations around the world. The largest of these are located in or proximate the oceans. One of the problems associated with wind energy conversion is the variable speed of the wind. It is desirable to maintain the electrical generator at a constant speed in order to generate a constant frequency AC power. Variations in the speed of the generator result in variations of the frequency of the electricity. This problem has been resolved in the past by varying the pitch of the blades of the wind turbine. Also, the blades of the wind turbine must be operated at low revolutions per minute (RPM) so that blade tip speeds do not exceed the speed of sound and for noise considerations. To do this, most wind turbines employ gear boxes to increase the RPM of the shaft to speeds that generators require for efficient operation. The generator speed of the wind turbine is determined by the grid frequency. These solutions, however, present problems by employing moving mechanical elements which tend to wear out and/or become misaligned.

### DESCRIPTION OF THE PRIOR ART

U.S. Published Patent Application No. 2002/0110522 discloses a method for the conversion of wind energy to produce hydrogen and oxygen gases. All of the processes are done at the site of the wind farm. The wind farms are preferably located in a body of water. The wind turbines produce electrical power which is fed through switched, protection devices and other devices to hydrogen conversion plants. Although the electrical power is not constant because the speed of the wind is not constant, the hydrogen conversion plants can still function under these conditions. Water is taken from the area surrounding the wind turbines and converted into hydrogen and oxygen which is then stored in containers.

U.S. Published Application No. 2007/0145748 discloses a power generation system including a wind turbine, an electrolysis unit, a tank, and a pump. The wind turbine is mounted to the floor of a body of water. The electrolysis unit is secured to the base of the wind turbine and is powered by the wind turbine. The tank is coupled to the electrolysis unit and stores the hydrogen which is generated by the electrolysis unit.

U.S. Pat. No. 6,918,350 discloses a method and system for generation of hydrogen and oxygen contained in salt solution. The system includes a number of wind turbines mounted on navigable vessels in offshore waters. The wind turbines preferably have 30 blades, each which provides high torque for generating electricity. The electricity is used to generate hydrogen and oxygen from water by electrolysis. The vessels are disposed in predetermined collection zones. These zones are changed depending on the prevailing weather conditions. The hydrogen and oxygen are stored in cylinders on the vessels and then transported to shore for use.

U.S. Pat. No. 5,592,028 discloses a system for smoothing electrical power output from wind powered electrical generators. The system utilizes some of the power output from a wind powered electrical generator to convert water into hydrogen, store and then burn the hydrogen to produce energy. This energy is then used to generate electricity. A plurality of electrolysis cells used to generate the hydrogen are connected in series to form a module. At least two modules are connected in parallel and controlled by switches to regulate the generation of hydrogen gas.

U.S. Published Patent Application No. 2007/0138006 discloses a hydrogen gas generation system for use in a mobile vehicle. The mobile vehicle may be, for example, a car or truck or other vehicle such as a balloon, dirigible, airship, ship, or boat. The vehicle has an on-board hydrogen generator for generating hydrogen gas, preferably using an electrolysis process. The hydrogen produced by the electrolysis process is stored in an on-board hydrogen storage tank. Hydrogen from the storage tank is flowed into a vehicle propulsion system where the hydrogen gas is consumed to provide power to propel the vehicle. An on-board electrical generation system provides at least some of the electricity for the electrolysis process. In one example, the vehicle has an on-board electrical generator for providing electricity for the electrolysis process. The on-board electric generation system may be, for example, a solar photovoltaic cell system, a wind turbine generator system, or a regenerative braking generator. Depending on the particular electrical generation process or processes used, the vehicle may generate hydrogen gas when moving, when coasting or braking, or when long-term parked.

### SUMMARY OF THE INVENTION

A wind turbine for use in the generation of electricity employs a generator which enables the efficient production of DC electrical power through the use of a low and variable speed and variable torque design. This design eliminates the cost and complexity of variable pitch turbine blades and/or mechanical gear boxes. The design includes a large diameter axial flux generator which utilizes either permanent magnets or current induced field coils. The design preferably employs an equal number of armature coils and field coils, or permanent magnets in the case of single phase operation, or 1⅓ field coils or a permanent magnet for every armature coil for 3-phase operation. The 3-phase operation can also be accomplished by using 3 separate rotor disks on the generator with appropriate indexing of the rotor disk and armature coils.

Accordingly, it is an objective of the present invention to provide a wind turbine for the generation of electricity wherein the gear box and the generator of a conventional turbine are replaced with a generator of the present invention.

It is a further objective of the instant invention to employ a generator on a wind turbine which would eliminate the use of variable pitch blades to control the optimal pitch for various wind speeds.

It is yet another objective of the instant invention to employ a newly designed and controlled axial flux generator on a wind turbine to control the speed of the wind turbine.

It is still yet another object of the instant invention to employ a newly designed and controlled axial flux generator on a wind turbine to limit the speed of the wind turbine.

It is a still further objective of the instant invention to employ an axial flux generator on a wind turbine which utilizes permanent magnets with a newly designed control system.

It is still a further object of the present invention to employ an axial flux generator on a wind turbine which utilizes induced field coils with a newly designed control system.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an overall view of the system for production of oxygen and hydrogen utilizing wind turbines;

FIG. 2 is a schematic of the electrical circuits and controls of the present invention;

FIG. 3 is a cross sectional view of an axial flux generator of the present invention;

FIG. 4 is a plan view of an armature coil employing current induced field coils;

FIG. 5 is a plan view of an armature coil employing permanent magnets; and

FIG. 6 is an exploded view of an armature coil of the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

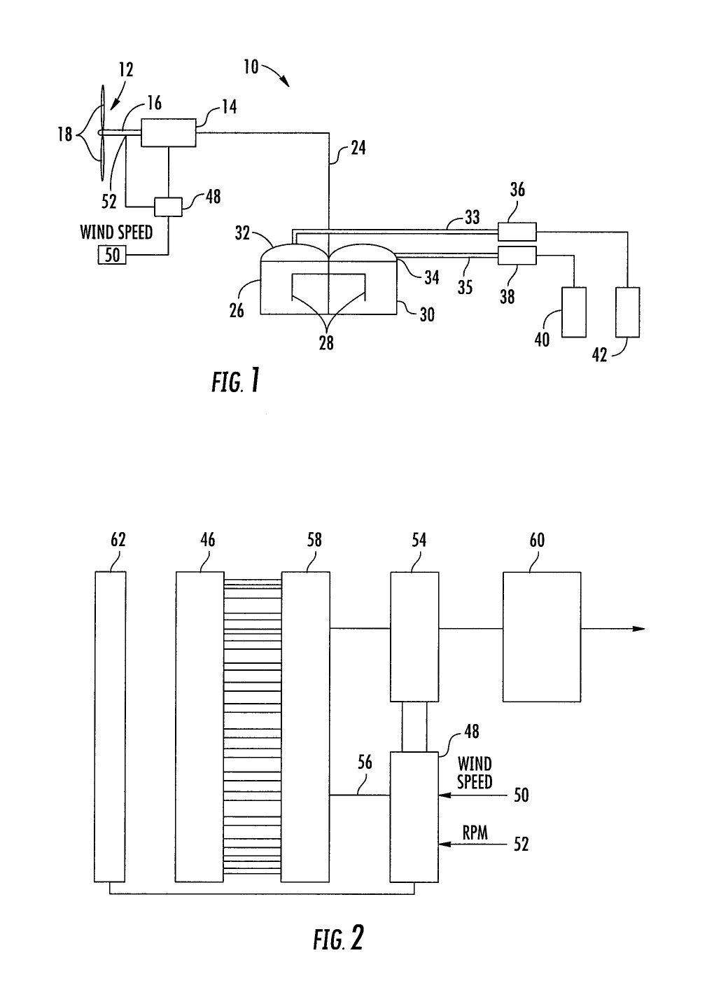

FIGS. 1-6, which are now referenced, illustrate the present invention and the manner in which it is assembled. A system for generating fuels by the utilization of wind is illustrated generally at 10. More specifically, a preferred embodiment of the present invention utilizes a wind turbine generator 12 to produce electricity. Most conventional wind turbines utilize a generator to produce electricity. This process results in Alternating Current (AC) electricity being produced by the generator and control system. The generator, also known as a dynamo, produces pulsating DC electric current through Faraday's law. A generator or dynamo consists of a stationary structure, called a stator, which provides a constant magnetic field and a set of rotating windings called an armature which turn within that magnetic field. Some generators or dynamos utilize permanent magnets to produce the constant magnetic field of the stator, while other generators or dynamos utilize electromagnets, called field coils, to produce the constant magnetic field. Conventional wind turbines also utilize a mechanical gear box to increase the speed of rotation of the wind turbine shaft. The production of usable Alternating Current (AC) electricity requires the turbine shaft speed to remain constant. During periods of extremely strong wind gusts, the turbine shaft experiences stress which is transferred to the wind turbine generator.

The present invention employs a large diameter axial flux generator in place of the generator of a conventional wind turbine. The axial flux generator is illustrated as 14 in FIG. 1. The shaft 16 of the wind turbine operates the field coils 62 of the axial flux generator. The wind turbine employs blades 18 which rotate the shaft 16 in response to wind passing by the blades. The system also includes a logic controller 48. The logic controller 48 receives a signal from a revolutions per minute (rpm) sensor 52 and a wind speed sensor 50, which indicates the rotational speed of shaft 16 and the speed of the wind. The logic controller 48 controls the number of armature coils in service and the field voltage (in the case of induced field coils) of the axial flux generator to control the speed of the shaft, as will be described in detail hereinafter.

The electricity produced by the wind turbine 12 is sent through cables/wires 24 to a fuel generation device 26. In a preferred embodiment, the fuel generation device 26 is a device which disassociates water into hydrogen and oxygen by electrolysis. A plurality of electrodes 28 are placed within a container of conditioned water 30 (water which is able to conduct electricity). When an electrical current is passed through the electrodes 28, the water is disassociated into hydrogen and oxygen. The fuel generation device 26 includes a plurality of collectors or domes 32, 34 which capture the hydrogen and oxygen. These gases are then sent through lines 33, 35 to compressors 36, 38. The compressors 36, 38 compress the gaseous hydrogen and oxygen into liquids which are stored in tanks 40, 42. The liquid forms of hydrogen and oxygen enable these fuels to be readily transported and utilized.

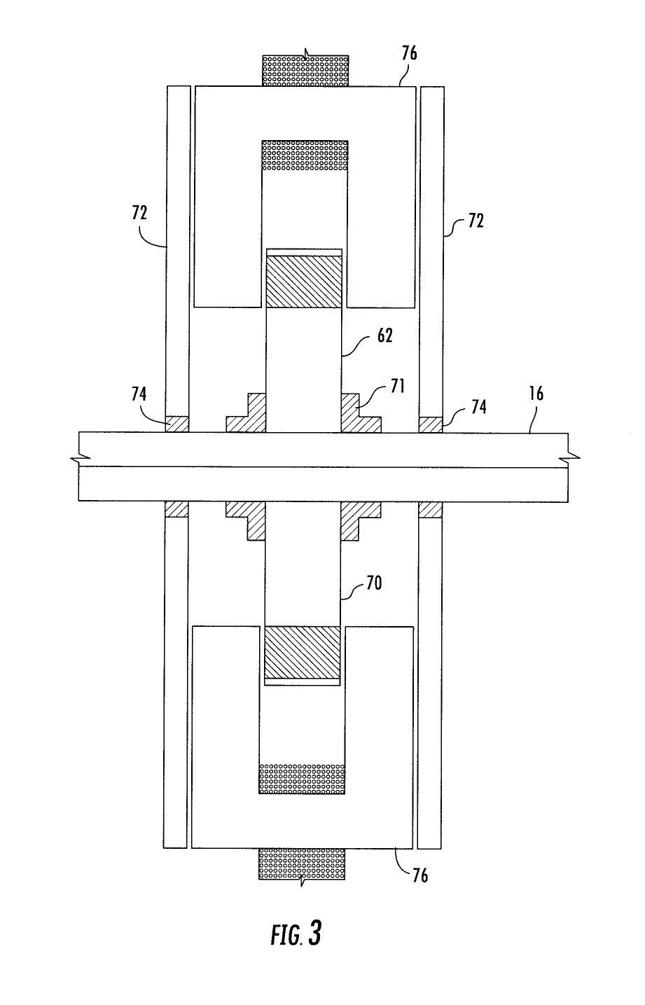

FIG. 2 illustrates the controls and circuitry for operating the axial flux generator 14. The axial flux generator includes field coils 62 and armature coils 46. A logic controller 48 receives inputs of the wind speed from a sensor 50 and the revolutions per minute (rpm) 52 sensor of shaft 16 of the wind turbine. This information is used to control the number of armature coils in operation and the field voltage (in the case of induced field coils).

The electrical output from the axial flux generator 14 has variable frequency and variable voltage mainly because of the variations in the speed of the wind. A transformer/regulator device 54 transforms this variable voltage to a constant voltage. A full wave rectifier 60 converts the output from the transformer/regulator 54 into direct current (DC) output.

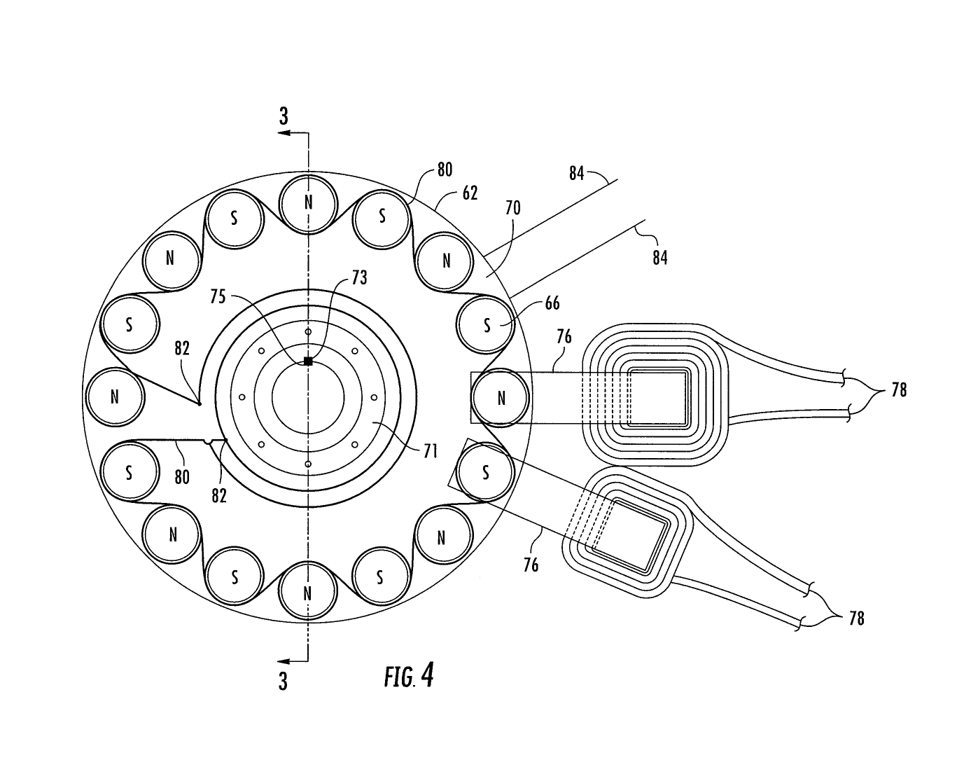

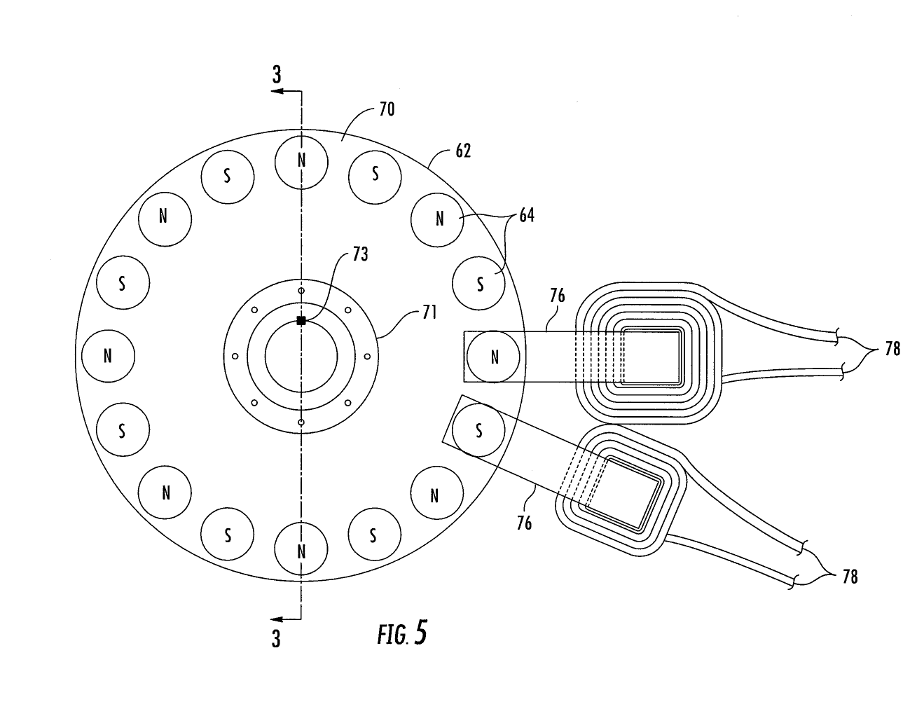

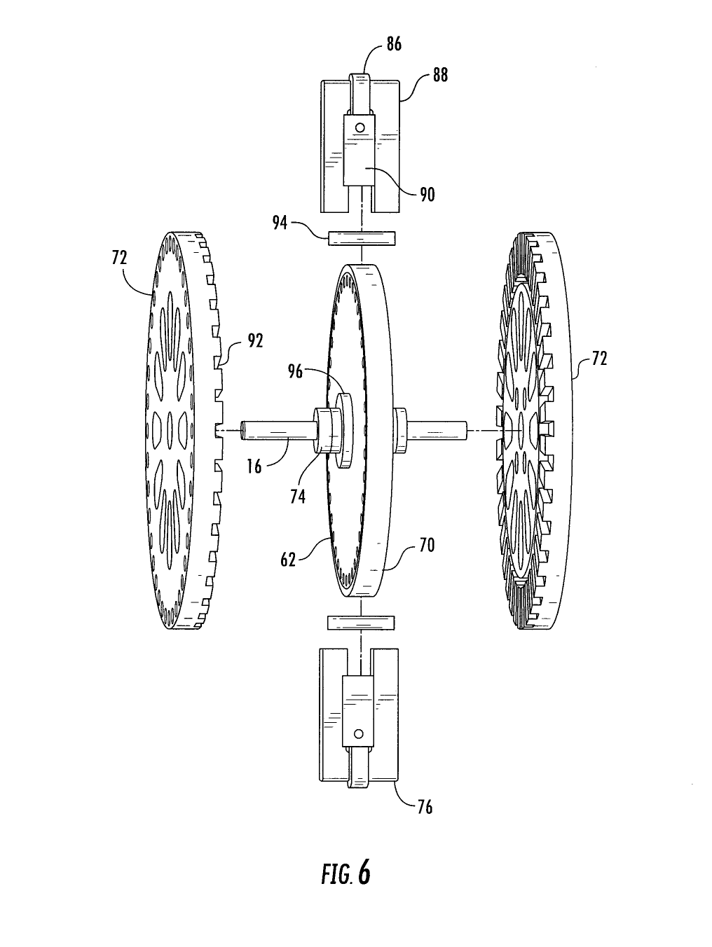

FIG. 3 is a cross sectional view of one embodiment of the armature and field coils of axial generator 14 taken along line 3-3 in FIGS. 4 and 5. The field coils 62 can be permanent magnets 64, as illustrated in FIG. 5 or current induced magnets 66, as illustrated in FIG. 4. These permanent magnets or current induced magnets are secured around a circumference of a plate or disc 70. The plate or disc 70 is secured to the shaft 16 of the turbine, utilizing a collar 71 and rotates with the shaft. A key 73 is positioned within a keyway 75 to help secure the collar and disc to shaft 16. The axial flux generator includes a housing 72 which is made from a non-magnetic material. The plates 72 are secured to shaft 16 with bearings 74 which permit the shaft 16 to rotate and the plates 72 to remain stationary. Armatures 76 are secured to the plates 72 so as to remain stationary with respect to the shaft 16 and field coils.

As the permanent magnets 64 or current induced magnets 66 pass by the armatures 76, an electric current is generated as a result of Faraday's law. This current is sent through wires 78 to the transformer/regulator 54, full wave rectifier 60, and then to the fuel generation device 26. The current induced magnets 66 are metallic elements 66 around which coils or wire are wrapped. When an electric current is passed through wires 80, the elements 66 become magnetic. When these magnetic elements 66 pass by the armatures 76, an electric current is also produced. This embodiment requires brushes or slip rings 82 mounted on the disc 70 to conduct the electrical current from the shaft 16 to the disc 70. The shaft 16 receives an electric current from wires 84.

FIG. 6 illustrates an exploded view of the axial flux generator. Shaft 16 has a disc 70, which is made from a non-magnetic material. A plurality of field coils 62 are mounted around the outer perimeter of disc 70. A plurality of armatures 76 are positioned around the outer perimeter of the disc 70. Each armature includes a core winding 86 of conductive wire, a core 88 of multiple plates formed from magnetic material and a core spacer 90, formed of a non-magnetic, non-conducting material. Each of the armatures 76 is positioned and held within slots 92 in the plates 72. A plurality of plate spacers 94 secure the plates 72 together. These spacers also maintain the proper spacing distance between the armatures 76 and the field coils 62. The disc 70 is also provided with a stabilizer bushing 96 which is preferably made from a non-magnetic material.

The axial flux generator of the present invention preferably utilizes an equal number of armature coils and field coils or permanent magnets. This design is utilized in single phase operation. When 3-phase operation is desired, 1⅓ field coils or permanent magnets for every armature coil are employed. Three phase operation can also be accomplished by using three separate rotor disks on the generator with appropriate indexing of the rotor disk and armature coils.

Electric current to the fixed armature disks can be switched on and off. They can also be connected in series, parallel, or any combination thereof. When the electric current is fed into the armature disks, they act as a brake and retard the rotation of the field coil. This action results in a decrease of the rotation of shaft 16. Thus, the speed of the wind turbine can be controlled in this manner. It is critical that the speed of the tips of the turbine blades do not exceed the maximum design speed of the turbine.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for generation of fuels comprising:
a hydrogen gas generator;
an oxygen gas generator;
said hydrogen gas generator and said oxygen generator utilizing electrolysis to generate said hydrogen and said oxygen gases;
a wind turbine, said wind turbine supplying an electrical current to said electrolysis;
a hydrogen gas compressor which compresses said hydrogen gas into a liquid;
a storage tank for storing said liquid hydrogen;
an oxygen gas compressor which compresses said oxygen gas into a liquid; and
a storage tank for storing said liquid oxygen.

2. The system of claim 1 wherein said wind turbine includes an axial flux generator and a control which controls the speed of a shaft of said wind turbine in response to the speed of the blades of the wind turbine and the speed of the wind.

3. The system of claim 2 wherein said axial flux generator includes a stationary armature and a rotating field coil.

4. The system of claim 3 wherein said field coil includes a plurality of current induced magnets secured proximate a circumference of said field coil.

5. The system of claim 3 wherein said field coil includes a plurality of permanent magnets secured proximate a circumference of said field coil.

6. The system of claim 2 wherein said control includes a logic controller which controls the number of armature coils in operation and the field voltage (in the case of induced field coils) in response to the speed of the wind and the speed of said shaft of said wind turbine to maintain the speed of said shaft within desirable parameters.

7. The system of claim 2 including a variable output transformer which regulates the voltage of the electrical output of said wind turbine and a full wave rectifier which produces direct current electrical output of said wind turbine.

8. A wind turbine including a plurality of blades secured to a shaft, an axial flux generator and a control system which controls the speed of said shaft of said wind turbine (variable torque control) in response to the speed of the blades of the wind turbine and the speed of the wind.

9. The wind turbine of claim 8 wherein said axial flux generator includes a stationary armature and a rotating field coil.

10. The wind turbine of claim 9 wherein said field coil includes a plurality of current induced magnets secured proximate a circumference of said field coil.

11. The wind turbine of claim 9 wherein said field coil includes a plurality of permanent magnets secured proximate a circumference of said field coil.

12. The wind turbine of claim 8 wherein said control includes a logic controller which controls the number of armature coils in service in response to the speed of the wind and the speed of said shaft of said wind turbine to maintain the speed of said shaft within desirable parameters.

13. The wind turbine of claim 8 including a variable output transformer which regulates the voltage of the electrical output of said wind turbine and a full wave rectifier which produces direct current electrical output of said wind turbine.

14. The wind turbine of claim 12 wherein said logic controller is the only controller which regulates the speed of said shaft of said wind turbine.
